(19) United States
(12) Patent Application Publication
(10) Pub. No.: US 2012/0306987 A1
(43) Pub. Date: Dec. 6, 2012

(54) PRINTING APPARATUS AND METHOD FOR PAPER CUP

(75) Inventor: Dong Gack KIM, Seoul (KR)

(73) Assignee: Myeong Ju KIM, Seoul (KR)

(21) Appl. No.: 13/438,415

(22) Filed: Apr. 3, 2012

(30) Foreign Application Priority Data
May 30, 2011 (KR) 10-2011-0051252
Aug. 4, 2011 (KR) 10-2011-0077709

(51) Int. Cl. B41J 2/435

(52) U.S. Cl. 347/224

(57) ABSTRACT

Provided is a paper cup printing apparatus including: a photographing unit that takes a photo; a printing unit that prints the photo taken by the photographing unit on the surface of a paper cup; and a control unit that converts the photo taken by the photographing unit into data for printing, and controls the printing unit to automatically print the photo on the surface of the paper cup. The paper cup printing apparatus prints user's face or favorite image on a paper cup for containing coffee or drink to thus encourage recycling of the paper cup and increase sales of coffee or drink.

### CROSS-REFERENCE TO RELATED APPLICATION

This application claims the benefit of Korean Patent Applications Nos. 10-2011-0077709, filed on Aug. 4, 2011, and 10-2011-0051252, filed on May 30, 2011, in the Korean Intellectual Property Office, the disclosure of which is incorporated herein by reference.

### BACKGROUND OF THE INVENTION

1. Field of the Invention

The present invention relates to a paper cup printing apparatus for printing a photo or image on a paper cup for containing coffee or drink and method thereof.

2. Description of the Related Art

Among the essential favorite foods of the moderns, there is a trend that coffee is increasingly consumed day by day. In particular, as take-out coffee shops are increasing, coffee put on disposable paper cups is being sold. In the Republic of Korea, the current annual consumption of paper cups is approximately estimated at 12 billion which corresponds to 1.2 million 20-year-old trees, and corresponds to the amount of reducing 120 billion tons of carbon dioxide.

Therefore, there is a need for suppressing use of paper cups. In the case that it is difficult to suppress the use of paper cups, the use of recycled paper cups should be recommended. The use of recycled paper cups will be able to reduce consumption of trees to thus reduce the amount of carbon dioxide that corresponds to the reduced consumption of paper cups.

The reduced use of paper cups has an effect of keeping and saving many trees and forests and will contribute to an eco-friendly green growth.

Thus, in order to reduce consumption of the paper cups, there is a need to develop the technology of leading people to re-use or recycle paper cups used.

Currently, a lottery or premium printed paper cup is disclosed in the Korean Patent Laid-open Publication No. 2002-0016070. The disclosed paper cup includes an advertising portion having an advertisement printed on the surface of the paper cup and a premium indicating portion that indicates premiums, in which a removable opaque printed layer is formed on the surface of the premium indicating portion, to thus make a user remove the opaque printed layer and ascertain whether or not premiums are won.

However, because the conventional paper cup has a pre-printed premium indicating portion and a consumer may discard the paper cup after she or he has ascertained whether or not premiums printed on the paper cup have been won, there a limit to induce the consumer to recycle the paper cup.

### SUMMARY OF THE INVENTION

To solve the above conventional problems or defects, it is an object of the present invention to provide a paper cup printing apparatus for automatically printing user's face or favorite images on a paper cup for containing coffee or drink to thus encourage recycling of the paper cup and a method thereof.

In addition, it is another object of the present invention to provide a paper cup printing apparatus for automatically printing user's face or favorite images on a paper cup for containing coffee or drink within a short time so that the paper cup can be used conveniently regardless of places of use and a method thereof.

Furthermore, it is still another object of the present invention to provide a paper cup printing apparatus for automatically printing user's face or favorite images on a paper cup for containing coffee or drink at a shop that specializes in selling the coffee or drink, to thereby provide an advantage of improving a sales effect and a method thereof.

The technical challenges that should be solved by the present invention are not limited to the above-mentioned technical challenges but the other technical challenges that have not been mentioned can be clearly understood by one who has an ordinary skill in the art to which the present invention belongs from the following description.

To accomplish the above and other objects of the present invention, according to an aspect of the present invention, there is provided a paper cup printing apparatus comprising:

a photographing unit that takes a photo;

a printing unit that prints the photo taken by the photographing unit on the surface of a paper cup; and

a control unit that converts the photo taken by the photographing unit into data for printing, and controls the printing unit to automatically print the photo on the surface of the paper cup.

Preferably but not necessarily, the photographing unit comprises:

a camera that takes a photo for printing;

a display that displays an image captured by the camera;

a manipulator that selects a background of the photo taken by the camera or selects any one of a cartoon form, a sketch form and a high contrast form.

Preferably but not necessarily, the printing unit comprises:

a laser unit that is vertically installed in a housing and that generates laser beams;

a scan head that is installed on a table that is installed in the lower surface of the housing, reflects the laser beams in the horizontal direction in which the laser beams are irradiated vertically downwards, and prints the photo on the surface of the paper cup; and

an alignment jig that is disposed in parallel with the scan head and that is disposed on the outside of the housing so that the paper cup for printing is placed and manually inserted and withdrawn.

Preferably but not necessarily, the scan head comprises:

a first reflective mirror that reflects the laser beams irradiated from the laser unit along the X-axis;

a first actuator that rotates the first reflective mirror and controls a reflective angle of the first reflective mirror;

a second reflective mirror that reflects the laser beams irradiated from the first reflective mirror along the Y-axis;

a second actuator that rotates the second reflective mirror and controls a reflective angle of the second reflective mirror; and

a scan lens that focuses the laser beams reflected from the second reflective mirror and irradiates the focused laser beams onto the surface of the paper cup.

Preferably but not necessarily, the paper cup printing apparatus further comprises a rotating drive that is placed in the alignment jig to thus rotate the paper cup, wherein the rotating drive comprises:

a driving motor that is fixed on the table; and

a rotating plate that is connected to the driving motor and is rotatably supported to the alignment jig, in which the paper cup is safely mounted on the rotating plate.

Preferably but not necessarily, the printing unit comprises:

a main body on the outer surface of which an exit is provided in which a paper cup is discharged through the exit;

a laser printer that is placed in the inside of the main body;

a cup dispenser that accommodates a plurality of paper cups;

a cup withdrawal portion that withdraws one of the paper cups accommodated in the cup dispenser to then be fixed on a cup holder;

a cup alignment portion that rotates the cup holder to make a printing position of the paper cup match the laser printer; and

a cup discharging portion that discharges the printing completed paper cup to the outside of the main body.

Preferably but not necessarily, the laser printer is a laser printing apparatus that uses a CO₂ gas.

Preferably but not necessarily, a cup detecting sensor is provided in the cup dispenser to thereby generate a signal if the number of the paper cups that are accommodated in the cup dispenser is reduced to a set value or less, and to thus notify an administrator of reduction in the number of the paper cups.

Preferably but not necessarily, a lifting rod is integrally connected to the underside of the cup holder, supported to one end of the rotating plate so as to be elevated, and connected to a lifting cylinder, and a first drive motor that makes the rotating plate rotate and makes one of the paper cups move to an exit hole of the cup discharging portion is connected to the other end of the rotating plate.

Preferably but not necessarily, the cup holder is connected to a vacuum tank, and has a suction hole that sucks one of the paper cups.

Preferably but not necessarily, the cup alignment portion comprises:

a sensing portion that detects the surface of the paper cup that is placed on the cup holder; and

a second drive motor that is fixed to the rotating plate to thus rotate the cup holder.

Preferably but not necessarily, the sensing portion detects a joint portion that is formed in the process of manufacturing the paper cup or a logo printed on the paper cup.

Preferably but not necessarily, a vacuum suction plate is provided at one side of the exit hole, to thus vacuum-suck the lateral surface of the paper cup to maintain the paper cup at a current position if the paper cup reaches the exit hole by rotation of the rotating plate.

According to another aspect of the present invention, there is provided a paper cup printing method comprising the steps of:

taking a photo;

editing the taken photo;

withdrawing a paper cup;

aligning the paper cup so that the location of the paper cup matches a print position;

printing the photo on the paper cup; and

discharging the paper cup, wherein

the paper cup alignment step comprises the sub-steps of:

rotating the paper cup;

detecting a joint portion or a printed pattern that is formed on the surface of the paper cup; and

stopping rotation of the paper cup if a printing surface of the paper cup is aligned with a laser printer each other.

Preferably but not necessarily, the paper cup withdrawing step comprises the sub-steps of:

lifting a cup holder to contact the lower surface of the paper cup;

vacuum-sucking the paper cup that is placed on the cup holder; and

descending the cup holder.

Preferably but not necessarily, the step of printing the photo on the paper cup comprises the sub-step of marking the photo on the surface of the paper cup, using the laser printer that uses a CO₂ gas.

Preferably but not necessarily, the paper cup discharging step comprises the sub-steps of:

making the cup holder on which the paper cup is placed move to an exit hole;

vacuum-sucking the lateral surface of the paper cup so that the paper cup is fixed on the upper surface of the exit hole;

making the cup holder move back to an original position; and

releasing the vacuum state of the paper cup to thus discharge the paper cup via the exit hole.

### Advantageous Effects

A paper cup printing apparatus according to the present invention includes a photographing unit that takes a photo, and a printing unit that prints the photo taken by the photographing unit on the surface of the paper cup and a method thereon automatically prints user's face or favorite images on the paper cup for containing coffee or drink, to thus encourage recycling of the paper cup.

In addition, the paper cup printing apparatus and method according to the present invention enables the printing unit to automatically print user's face or favorite images on a paper cup for containing coffee or drink within a short time so that the paper cup can be used conveniently regardless of places of use.

Furthermore, the paper cup printing apparatus and method automatically prints user's face or favorite images on a paper cup for containing coffee or drink at a shop that specializes in selling the coffee or drink, to thereby provide an advantage of improving a sales effect and a method thereof.

### BRIEF DESCRIPTION OF THE DRAWINGS

FIG. 1 is a block diagram showing a paper cup printing apparatus according to the present invention.

FIG. 2 is a side view showing a printing unit according to a first embodiment of the present invention.

FIG. 3 shows a configuration of a scan head according to the first embodiment of the present invention.

FIG. 4 is a cross-sectional view showing a paper cup rotating drive according to the first embodiment of the present invention.

FIG. 5 is a perspective view of the printing unit according to a second embodiment of the present invention.

FIGS. 6 and 7 show an operational status of the printing unit according to the second embodiment of the present invention, respectively.

FIG. 8 is a perspective view of the printing unit according to the second embodiment of the present invention.

FIG. 9 show an operational status of a withdrawal portion in the printing unit according to the second embodiment of the present invention.

FIG. 10 is a side view showing the printing unit according to the second embodiment of the present invention.

FIGS. 11 and 12 show an operation of a paper cup discharging portion according to the second embodiment of the present invention.

FIG. 13 is a cross-sectional view showing the paper cup discharging portion according to the second embodiment of the present invention.

FIG. 14 is a flowchart view illustrating a process of a paper cup printing method according to the second embodiment of the present invention.

### DETAILED DESCRIPTION OF THE INVENTION

The above and/or other objects and/or advantages of the present invention will become more apparent by the following description.

Hereinbelow, with reference to the accompanying drawings, a paper cup printing apparatus and method according to respective embodiments according to the present invention will be described in detail. In this process, size, shape, etc., of components illustrated in the drawings may be exaggerated for clarity and convenience of description. In addition, terms that are specifically defined considering configuration and function of the present invention may vary according to users' or operators' intention or practice. Definitions for these terms should be made based on description given throughout this specification.

In the case that the paper cup printing apparatus according to this embodiment is installed in a coffee shop as an example, a face or desired image of a consumer who orders coffee or drink can be printed on a paper cup during manufacturing the ordered coffee or drink, so that the paper cup printed with the consumer's face or desired image is filled with the ordered coffee or drink to then be supplied to the consumer.

As described above, since the paper cup on which the consumer's face or desired image is printed is filled with the ordered coffee or drink to then be provided to the consumer, he or she will not easily throw away the paper cup that has been once used, to thus reduce consumption of paper cups.

Since the paper cup printing apparatus according to an embodiment of the present invention prints a photo or image on the paper cup during manufacturing coffee or drink, it should print the photo or image on the paper cup quickly and automatically.

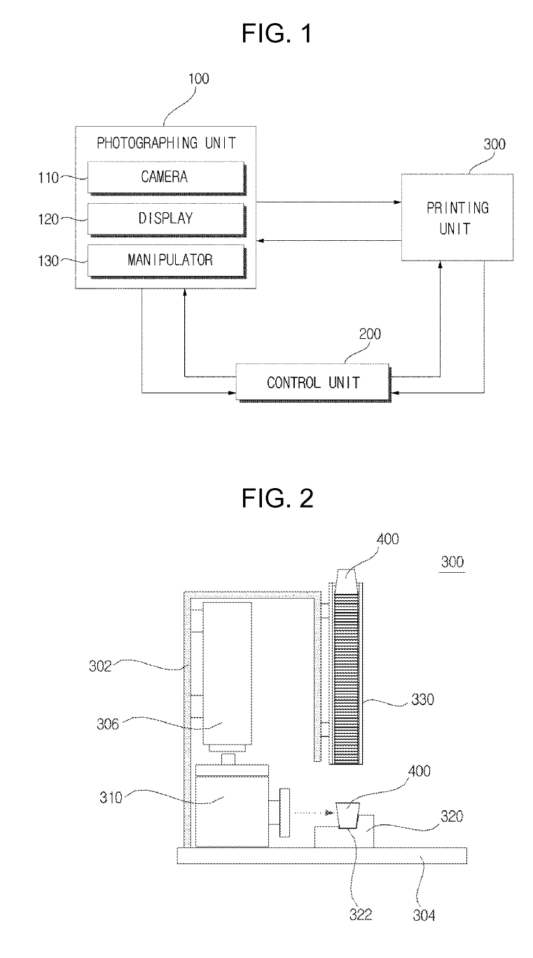

FIG. 1 is a block diagram showing the entire configuration of a paper cup printing apparatus according to the invention.

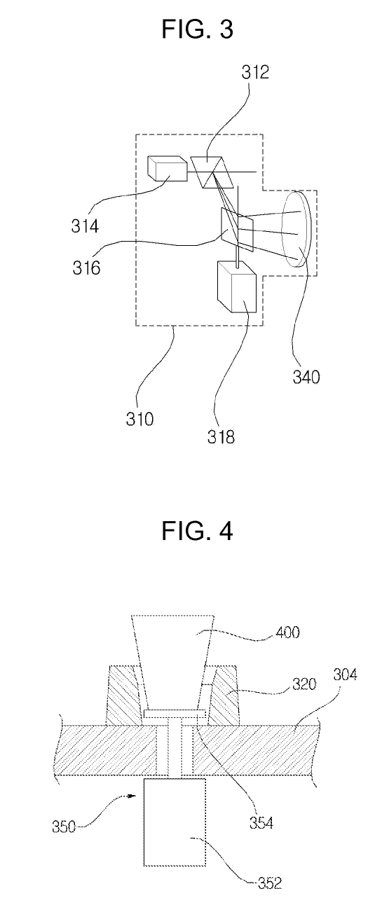

Referring to FIG. 1, the paper cup printing apparatus according to the present invention includes: a photographing unit 100 that takes a photo such as user's face, body or desired image; a printing unit 300 that prints the photo taken by the photographing unit 100 on the surface of a paper cup 400 (see FIG. 2); and a control unit 200 that converts the photo taken by the photographing unit 100 into data for printing, and controls the printing unit 300 to automatically print the photo on the surface of the paper cup 400.

The photographing unit 100 includes: a camera 110 that photographs a photo such as user's face or image; a manipulator 130 that is manipulated or operated directly by a user or seller; and a display 120 that displays a process of confirming or printing the photo taken by the user or seller.

The manipulator 130 may include a photographing button for photographing a photo; select buttons for selecting a background of the photo taken by the camera or selecting a photo form such as a cartoon form, a sketch form or a high contrast form; and a printing button for generating a signal that prints the photo on the paper cup.

The manipulator 130 may include buttons that perform various functions in addition to these buttons.

In this embodiment, the camera 110 for taking a photo may be installed in the printing unit 300 or may be installed at a place where a photo can be conveniently taken separately from the printing unit 300. In particular, the camera 110 may be installed at a position where coffee is ordered in a coffee shop.

FIG. 2 is a side view showing a printing unit according to a first embodiment of the present invention.

The printing unit 300 according to the first embodiment includes: a laser unit 306 that generates a laser beam; a scan head 310 that receives the laser beam generated in the laser unit 306, irradiates the received laser beam onto the surface of the laser beam of a paper cup 400, and controls a direction of the laser beam; and an alignment jig 320 that is placed in parallel with the scan head 310 to thus align the paper cup so that the scan head 310 faces the lateral surface of the paper cup 400.

The laser unit 306 is vertically erected in a housing 302, in which a laser beam irradiator that irradiates a laser beam is placed so as to face downward. Accordingly, the laser beam is irradiated vertically downwards. A table 304 is placed at the bottom of the housing 302, and the scan head 310 and the alignment jig 320 are installed on the table 304.

The laser unit 306 controls an intensity of the laser beam in accordance with a signal applied from the control unit 200, and is turned on or off according to a signal applied from the control unit 200.

The laser unit 306 prints a photo on the surface of a paper cup of a round form, using a laser beam and is a laser device using a CO₂ gas.

The scan head 310 is installed in the inside of the housing 302 and the alignment jig 320 is installed at the outside of the housing 302 so that it is convenient for a user to manually put a paper cup 400 on the alignment jig 320.

In addition, a paper cup dispenser 330 containing a plurality of paper cups 400 is installed on the outer surface of the housing 302.

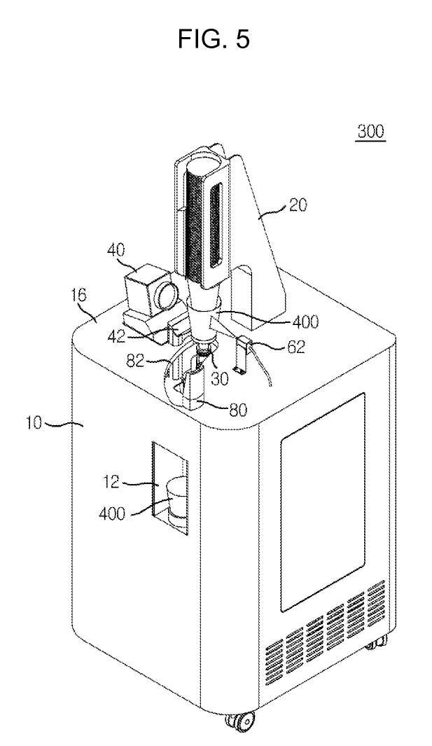

As shown in FIG. 3, the scan head 310 includes: a first reflective mirror 312 that reflects the laser beams irradiated from the laser unit 306 along the X-axis; a first actuator 314 that is connected with the first reflective mirror 312, to thereby rotate the first reflective mirror and control a reflective angle of the first reflective mirror 312; a second reflective mirror 316 that reflects the laser beams irradiated from the first reflective mirror 312 along the Y-axis; a second actuator 318 that rotates the second reflective mirror 316 and controls a reflective angle of the second reflective mirror 316; and a scan lens 340 that focuses the laser beams reflected from the second reflective mirror 316 and irradiates the focused laser beams onto the surface of the paper cup 400.

The scan head 310 is configured to sufficiently print a photo or image on the surface of a paper cup 400 whose surface is of a round form.

The first actuator 314 and the second actuator 318 are actuated by a signal applied from the control unit 200, to thus play a role of controlling an irradiation angle of a laser beam irradiated from the laser unit 306 and making a photo or image printed on the surface of a paper cup 400.

In addition to the above-described structure of the scan head 310, it is also possible to use any structure of the scan head that receives the laser beam irradiated from the laser unit 200 and that prints a photo or image on the surface of a paper cup 400.

The alignment jig 320 is fixed on the upper surface of the table 304, and is placed in parallel with the scan head 310, in which a mount groove 322 is formed to settle the paper cup 400 on the upper surface of the alignment jig 320.

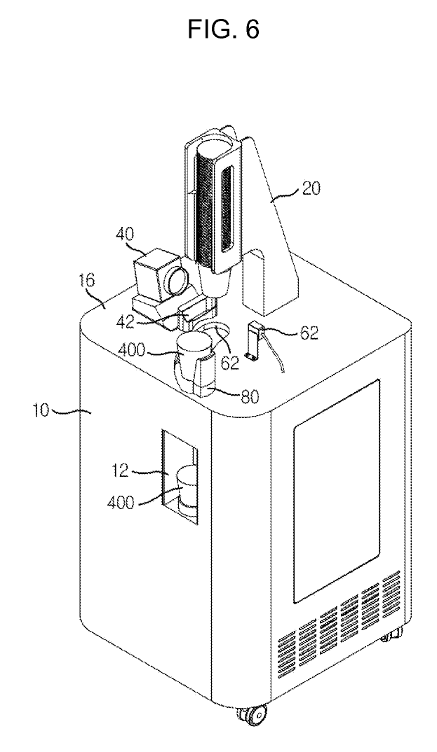

As shown in FIG. 4, a rotating drive 350 that can rotate a paper cup 400 in the alignment jig 320. In other words, in the case that a printing area of a paper cup 400 is large, the paper cup 400 is rotated so as to print a photo or image over the broad surface of the paper cup.

The rotating drive 350 includes: a driving motor 352 that is fixed on the table 304; and a rotating plate 354 that is connected to the driving motor 352 and is rotatably supported to the alignment jig 320, in which the paper cup 400 is safely mounted on the rotating plate 354.

Thus, the function of the printing unit having the above-described configuration according to the first embodiment will be described below.

First, a photo is taken by the camera 110. In other words, a user such as an administrator or consumer takes a photo that is required for printing while confirming an image displayed on the display 120. As an example, the face of a consumer who orders coffee at a coffee shop will be taken.

Once the photo has been completely taken, the consumer selects a background of the photo or selects a photo form such as a cartoon form, a sketch form or a high contrast form. After selection of the background or the photo form has been completed, the photo is converted into data necessary for printing.

Then, a paper cup among the paper cups contained in the cup dispenser 330 is put on the alignment jig 320 by the user.

Then, if the printing unit is operated, the control unit 200 controls the laser unit 306 to operate as well as the first actuator 314 and the second actuator 318 of the scan head 310 to operate. Then, a laser beam is irradiated vertically downwards from the laser unit 306. The laser beam generated in the laser unit 306 is focused through the scan head 310, and is irradiated on the surface of the paper cup 400 placed in the alignment jig 320. Accordingly, the photo or image is printed on the surface of the paper cup 400.

Once the paper cup 400 has been completely printed, the user will take out the paper cup 400 from the alignment jig 320.

Since the user aligns the paper cup 400 at a printing position and then performs printing on the aligned paper cup 400 in the paper cup printing apparatus according to the first embodiment of the present invention, the structure of the paper cup printing apparatus is simplified to reduce the manufacturing cost, and the volume in size of the paper cup printing apparatus is compact to then be conveniently installed.

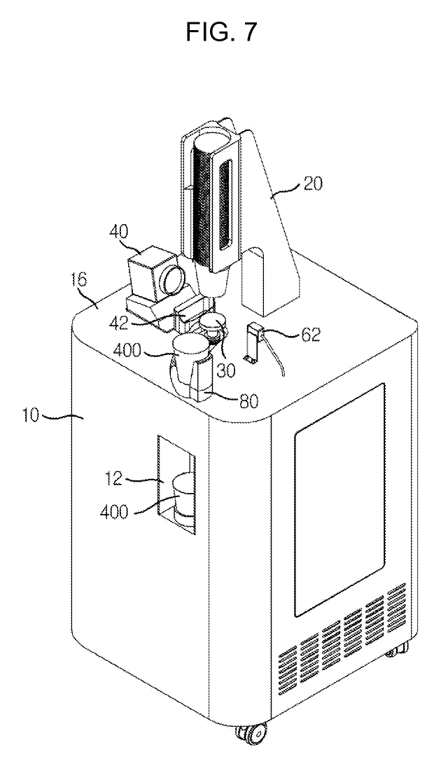

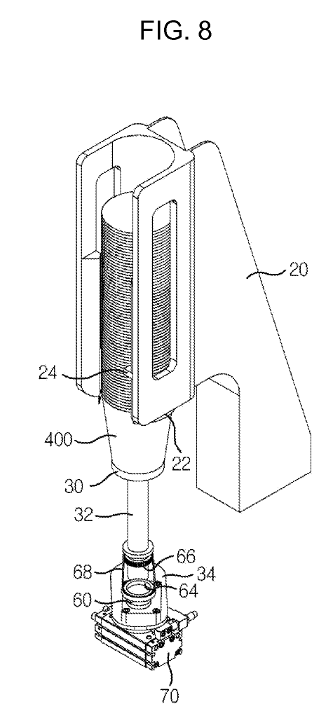

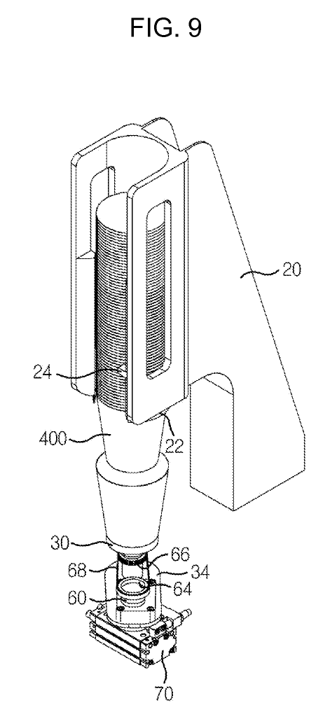

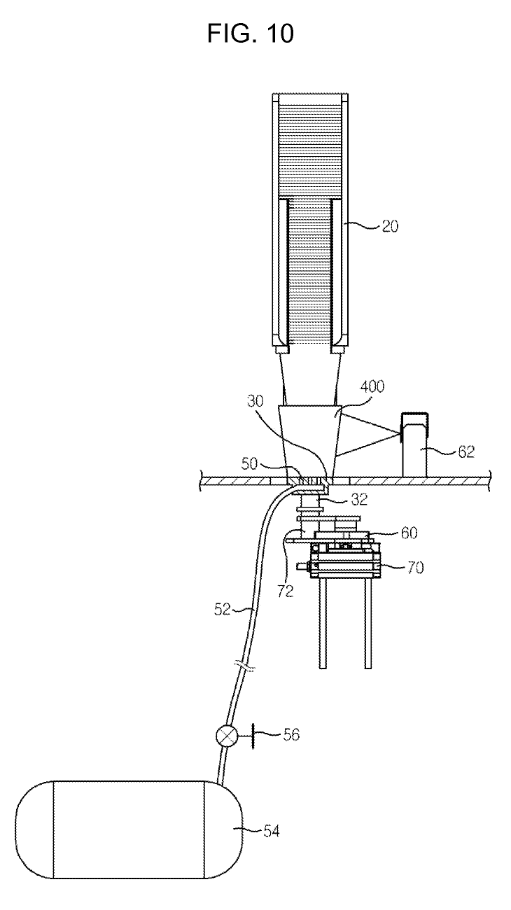

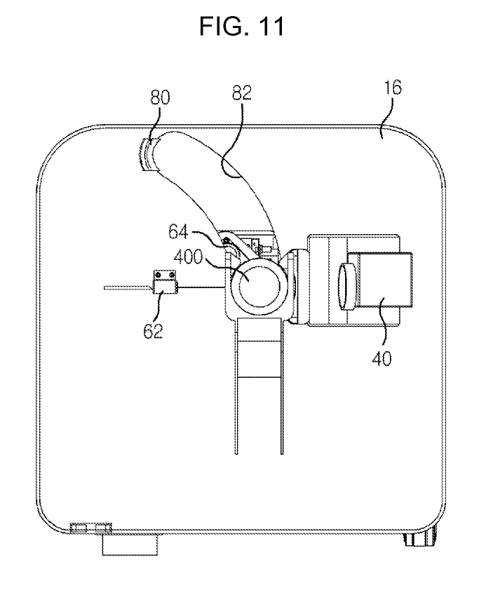

FIG. 5 is a perspective view of the printing unit according to a second embodiment of the present invention. FIGS. 6 and 7 show an operational status of the printing unit according to the second embodiment of the present invention, respectively. FIG. 8 is a perspective view of the printing unit according to the second embodiment of the present invention. FIG. 9 show an operational status of a withdrawal portion in the printing unit according to the second embodiment of the present invention. FIG. 10 is a laterally cross-sectional view showing the printing unit according to the second embodiment of the present invention.

The printing unit 300 according to the second embodiment of the present invention includes: a main body 10 that forms an external appearance;

a cup dispenser 20 that is placed in the inside of the main body 10 and that accommodates a plurality of paper cups; a cup withdrawal portion that withdraws one of the paper cups accommodated in the cup dispenser 20 to then be fixed on a cup holder 30; a cup alignment portion that rotates the cup holder 30 to align the paper cup 400 to match a printing position of the paper cup; a laser printer 40 that prints a photo or image on the surface of the paper cup 400; and a cup discharging portion that discharges the printing completed paper cup to the outside of the main body 10.

A paper cup exit 12 is provided on one lateral surface of the main body 10 in which the printing completed paper cup 400 is discharged through the exit 12. Although it is not shown in the drawings, a door is provided in the front surface of the upper side of the main body 10, in which the door is opened to repair components or supplement paper cups. A base frame 16 is horizontally formed in the inside of the main body 10. The inside of the main body 10 is partitioned into the upper and lower compartments by the base frame 16.

The cup dispenser 20 is vertically fixed on the upper surface of the base frame 16 in which a plurality of paper cups 400 are accommodated and stacked vertically, in which the paper cup 400 that is placed at the lowest position among the plurality of the paper cups 400 is stopped by a stopper rib 22 that is formed at the bottom of the cup dispenser 20.

Here, the stopper rib 22 is designed to catch the upper border portion of the paper cup 400 in which if the paper cup 400 is pulled downward by a certain force, the paper cup is escaped from the stopper rib 22.

A cup detecting sensor 24 is provided in the cup dispenser 20, to thereby generate a signal for the control unit 200 if the number of the paper cups 400 that are accommodated in the cup dispenser 20 is reduced to a set value or less, and to thus notify an administrator of reduction in the number of the paper cups 400 to then make the administrator supplement the paper cups.

In other words, if the number of the paper cups 400 that are accommodated in the cup dispenser 20 is reduced to a set value or less, the cup detecting sensor 24 generates the signal and transfers it to the control unit 200. The control unit 200 controls the display 120 to display the signal that informs the administrator to supplement paper cups to thus make the administrator confirm the signal. Otherwise, an alarm lamp is installed in the main body 10, in which the alarm lamp is actuated to inform the administrator to supplement paper cups, if the number of the paper cups 400 that are accommodated in the cup dispenser 20 is reduced to a set value or less.

A lifting rod 32 is fixed to the underside of the cup holder 30, supported to one end of the rotating plate 34, and connected to a lifting cylinder 72, so as to be elevated.

A first drive motor 70 that makes the rotating plate 34 rotate is connected to the other side of the rotating plate 34, and the lifting cylinder 72 is fixed in the inside of the main body 10.

A cup withdrawal portion that withdraws one of the paper cups accommodated in the cup dispenser 20 to the cup holder 30 is connected to the cup holder 30. The cup withdrawal portion includes: a plurality of suction holes 50 that are formed on the cup holder 30 to vacuum-suck one of the paper cups 400; the lifting rod 32 that is fixed to the cup holder 30; and the lifting cylinder 72 that lifts the lifting rod 32 up and down.

The plurality of the suction holes 50 are connected to a hose 52, and the hose 52 is connected to a vacuum tank 54 that is installed in the inner surface of the bottom of the min body 10. Then, a first valve 56 is installed at one side of the vacuum tank 54 to open or close the hose 52 and the first valve 56 is operated in accordance with a signal applied from the control unit 200.

The function of the paper cup withdrawal portion will be described below. If the lifting cylinder 72 is driven, the lifting rod 32 rises up, and accordingly the cup holder 30 rises up and contacts the lower surface of the paper cup 400 that is housed in the lowest position of the paper cup dispenser 20. If the first valve 56 is activated to thus open the hose 52, vacuum pressures are generated for the suction holes 50, thus causing the paper cup 400 to be vacuum-adsorbed on the cup holder 30.

If the lifting cylinder 72 is driven in the opposite direction to then make the cup holder 30 descend, the paper cup 400 is withdrawn from the paper cup dispenser 20, to then be fixed to the cup holder 30.

The cup alignment portion includes: a second drive motor 60 that is installed on the upper surface of the rotating plate 34 to rotate the cup holder 30; and a sensing portion 62 that is installed on the upper surface of the base frame 16 to thus sense the surface of the paper cup 400 placed in the cup holder 30 and transfer the sensed result signal to the control unit 200.

A drive gear 64 is fixed on the drive shaft of the second drive motor 60, and a driven gear 66 that is spline-combined on the outer peripheral surface of the lifting rod 32 and that is made to rotate with the lifting rod 32 is fixed on the drive shaft of the second drive motor 60. The drive gear 64 and the driven gear 66 are wound and connected with a timing belt 68.

A logo is printed on the surface of a paper cup 400 and a joint portion is formed on the outer circumferential surface of the paper cup 400 in which paper is rolled and the end portions of the rolled paper are jointed during manufacturing paper cups. Thus, printing should be performed on the surface of the paper cup 400 that is free from the logo printed on the surface of the paper cup 400 and the joint portion of the paper cup 400.

To this end, the sensing portion 62 is a sensor that detects the joint portion of the paper cup 400 or the logo printed on the surface of the paper cup 400, and transfers the detection signal to the control unit 200.

The function of the paper cup alignment portion will be described below. The sensing portion 62 detects the outer surface of the paper cup 400 and transfers the detection signal to the control unit 200. Then, the control unit 200 drives the second drive motor 60. Then, the driven gear that is spline-combined with the outer peripheral surface of the lifting rod 32 is made to rotate and makes the lifting rod 32 rotate.

Here, the lifting rod 32 is connected with the lifting cylinder 72. A bearing that rotatably supports the lifting rod 32 may be installed between the lift cylinder 72 and the lifting rod 32.

After having determined the outer surface of the paper cup 400, a clean surface having no joint portion or logo on the outer surface of the paper cup is placed facing the laser printer 40.

The laser printer 40 prints a photo on the surface of a paper cup of a rounded form, using a laser beam, and is a laser printing apparatus using a CO₂ gas. It is possible to use any device for printing a photo taken by a camera 110 on the surface of a paper cup of a rounded form as the laser printer 40.

A suction plate 42 is installed in the laser printer 40 in order to discharge ashes or foreign matters that are produced during printing a photo or image on the surface of the paper cup using the laser printer 40.

Here, the front surface of the suction plate 42 is formed in the form of a curved form, and a plurality of suction holes are formed in the front surface of the curved front surface of the suction plate 42, to thereby suck and discharge the ashes or foreign matters that are produced during printing to the outside through the suction holes.

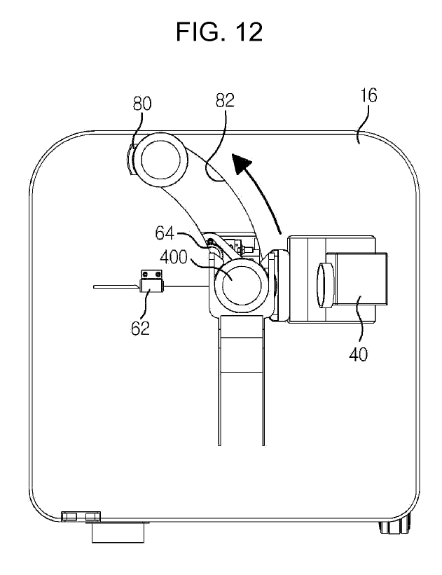

As illustrated in FIGS. 10 to 11, the cup discharging portion discharges the printing completed paper cup 400 to the outside of the main body 10, and includes: a first drive motor 70 that makes the rotating plate rotate and makes the paper cup placed on the cup holder 30 move to the upper surface of an exit 12 of the cup discharging portion; and a vacuum suction plate 80 that is installed on the upper surface of the base frame 16 to thus vacuum-suck the lateral surface of the paper cup 400.

An exit hole (92) through which the paper cup 400 is discharged is formed in the base frame 16, and the vacuum suction plate 80 is installed at one side of the exit hole (92).

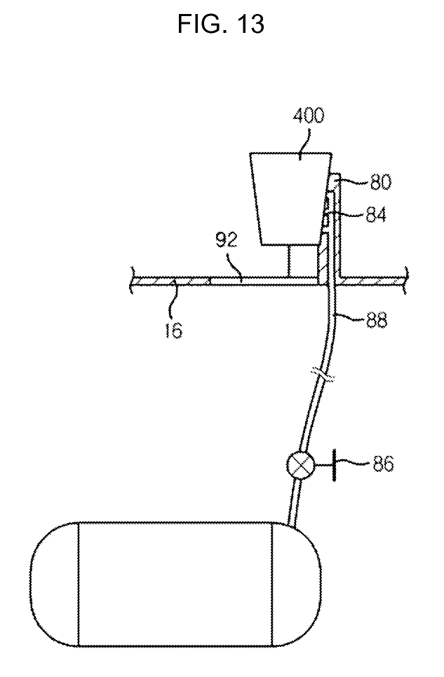

As shown in FIG. 13, the vacuum suction plate 80 is formed in a curved form to be in contact with the lateral surface of the paper cup 400. A plurality of suction holes 84 are formed on the vacuum suction plate 80, to thus suck the lateral surface of the paper cup 400. Here, the suction holes 84 are connected to a vacuum tank 54 via a hose 88. A second valve 86 that opens or closes the hose 88 is installed at one side of the hose 88.

A curved slot 82 along which the cup holder 30 moves in which the paper cup 30 is placed on the cup holder 30 is formed on the base frame 16.

The function of the cup discharging portion having the above-described configuration will be described below. If a paper cup 400 placed on the cup holder 30 has been completely printed, the first drive motor 70 is driven to make the rotating plate 34 rotate by 90 degrees. Then, the cup holder 30 moves along the slot 82 and is located on the upper surface of the exit hole (92), and the paper cup 400 is sucked by the suction plate 80 to thus stay at a current position.

Under the circumstances, the rotating plate 34 is made to rotate reversely to return to the original position, and the paper cup 400 is adsorbed by the suction plate 80 to thus maintain the state where the paper cup 400 is positioned on the upper surface of the exit hole (92). Then, a vacuum suction force of the suction plate 80 is removed, and thus the paper cup 400 freely falls down to the exit 12 formed in the main body 19 via the exit hole (92).

As described above, a control method of the paper cup printing apparatus having the above-described configuration according to the embodiment of the present invention, will be described below.

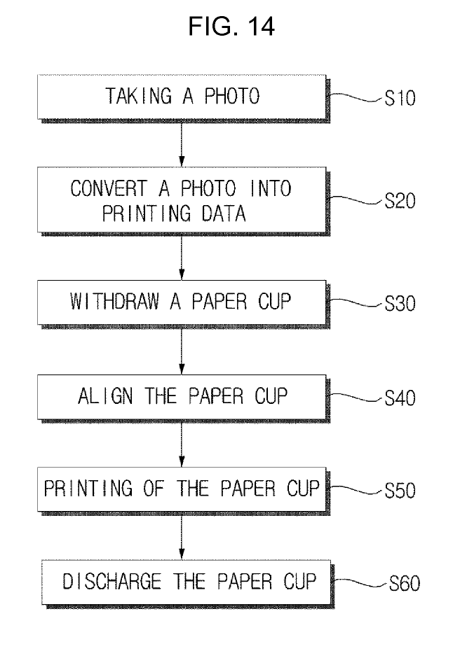

FIG. 14 is a flowchart view illustrating a process of a paper cup printing method according to the second embodiment of the present invention.

Referring to FIG. 14, a photo is taken by the camera 110 (S10). In other words, a user such as an administrator or consumer takes a photo that is required for printing while confirming an image displayed on the display 120. As an example, the face of a consumer who orders coffee at a coffee shop will be taken.

Once the photo has been completely taken, the consumer selects a background of the photo or selects a photo form such as a cartoon form, a sketch form or a high contrast form. After selection of the background or the photo form has been completed, the photo is converted into data necessary for printing (S20).

Then, a paper cup is withdrawn among a plurality of paper cups 400 contained in the cup dispenser 20 and is put on the cup holder 30 under the control of the control unit 200 (S30). In other words, the control unit 200 controls the lifting cylinder 72 to be driven. Then, the cup holder 30 rises up to be in contact with the lower surface of the paper cup 400. In this state, if the first valve 56 is activated to open the hose 52, a vacuum suction force is generated for the cup holder 30, thus causing a paper cup 400 to be adsorbed on the cup holder 30. Meanwhile, if the lifting cylinder 72 is driven in the reverse direction, the cup holder 30 falls down to thus make the paper cup 400 placed at a printing position.

Then, the paper cup 400 is aligned at the print position (S40). In other words, if the control unit 200 controls the second drive motor 60 to be driven, the cup holder 30 is rotated and the sensing portion 62 detects the surface of the paper cup 400, to then transfer the detection signal to the control unit 200.

Then, the control unit 200 confirms the logo printed on the paper cup 400 and the joint portion formed in the paper cup 400. If the printing surface free from the logo or joint portion of the paper cup 400 faces the laser printer 40 each other, the second drive motor 60 is stopped.

As described above, the printing position of the paper cup 400 and the position of the laser printer 40 are aligned with each other.

Then, the laser printer 40 is activated to print a photo or image on the surface of the paper cup 400 (S50).

If the paper cup 400 has been completely printed, the paper cup 400 is discharged to the outside of the main body 10 (S60). In other words, the control unit 200 controls a first drive motor 60 to be driven. The rotating plate 34 is rotated and the cup holder 30 on which the paper cup 400 is placed is made to move to the upper surface of the exit hole (92). Then, a vacuum suction force is provided for the suction plate 80 that is installed on the upper surface of the base frame 16, to thus make the lateral surface of the paper cup 400 adsorbed onto the suction plate 80.

If the first drive motor 60 is driven in the reverse direction, the rotating plate 34 returns to the original position and only a paper cup 400 that has been adsorbed onto the suction plate 80 is left. Under these conditions, if the vacuum suction force is removed from the suction plate 80, the paper cup 400 freely falls down to the exit 12 via the exit hole (92).

A cup detecting sensor 24 detects whether or not the number of the paper cups 40 that are accommodated in the cup dispenser 20 is reduced to a set value or less, during printing a photo or image on the paper cup 400. The cup detecting sensor 24 generates a signal that notifies an administrator of reduction in the number of the paper cups and transfers the detection signal to the control unit 200. The control unit 200 generates a paper cup supplementing signal to make the administrator confirm that the number of the paper cups 40 has been reduced to a set value or less, using a variety of alarm systems such as an alarm lamp and an alarm sound generator.

A paper cup printing apparatus according to the present invention is a printer that enables a user such as an administrator or consumer to directly print consumer's face or desired image on the surface of a paper cup at a shop that sells coffee or drink.

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

What is claimed is:

1. A paper cup printing apparatus comprising:
a photographing unit that takes a photo;
a printing unit that prints the photo taken by the photographing unit on the surface of the paper cup; and
a control unit that converts the photo taken by the photographing unit into data for printing, and controls the printing unit to automatically print the photo on the surface of the paper cup.

2. The paper cup printing apparatus according to claim 1, wherein the photographing unit comprises:
a camera that takes a photo for printing;
a display that displays an image captured by the camera;
a manipulator that selects a background of the photo taken by the camera or selects any one of a cartoon form, a sketch form and a high contrast form.

3. The paper cup printing apparatus according to claim 1, wherein the printing unit comprises:
a laser unit that is vertically installed in a housing and that generates laser beams;
a scan head that is installed on a table that is installed in the lower surface of the housing, reflects the laser beams in the horizontal direction in which the laser beams are irradiated vertically downwards, and prints the photo on the surface of the paper cup; and
an alignment jig that is disposed in parallel with the scan head and that is disposed on the outside of the housing so that the paper cup for printing is placed and manually inserted and withdrawn.

4. The paper cup printing apparatus according to claim 3, wherein the scan head comprises:
a first reflective mirror that reflects the laser beams irradiated from the laser unit along the X-axis;
a first actuator that rotates the first reflective mirror and controls a reflective angle of the first reflective mirror;
a second reflective mirror that reflects the laser beams irradiated from the first reflective mirror along the Y-axis;
a second actuator that rotates the second reflective mirror and controls a reflective angle of the second reflective mirror; and
a scan lens that focuses the laser beams reflected from the second reflective mirror and irradiates the focused laser beams onto the surface of the paper cup.

5. The paper cup printing apparatus according to claim 3, wherein a paper cup dispenser containing a plurality of paper cups is installed on the outer surface of the housing.

6. The paper cup printing apparatus according to claim 3, further comprising a rotating drive that is placed in the alignment jig to thus rotate the paper cup, wherein the rotating drive comprises:
a driving motor that is fixed on the table; and
a rotating plate that is connected to the driving motor and is rotatably supported to the alignment jig, in which the paper cup is safely mounted on the rotating plate.

7. The paper cup printing apparatus according to claim 1, wherein the printing unit comprises:
a main body on the outer surface of which an exit is provided in which the paper cup is discharged through the exit;
a laser printer that is placed in the inside of the main body;
a cup dispenser that accommodates a plurality of paper cups;
a cup withdrawal portion that withdraws one of the paper cups accommodated in the cup dispenser to then be fixed on a cup holder;
a cup alignment portion that rotates the cup holder to make a printing position of the paper cup match the laser printer; and
a cup discharging portion that discharges the printing completed paper cup to the outside of the main body.

8. The paper cup printing apparatus according to claim 7, wherein the laser printer is a laser printing apparatus that uses a CO₂ gas.

9. The paper cup printing apparatus according to claim 7, wherein a cup detecting sensor is provided in the cup dispenser, to thereby generate a signal if the number of the paper cups that are accommodated in the cup dispenser is reduced to a set value or less, and to thus notify an administrator of reduction in the number of the paper cups.

10. The paper cup printing apparatus according to claim 7, wherein a lifting rod is integrally connected to the underside of the cup holder, supported to one end of the rotating plate so as to be elevated, and connected to a lifting cylinder, and a first drive motor that makes the rotating plate rotate and makes one of the paper cups move to an exit hole of the cup discharging portion is connected to the other end of the rotating plate.

11. The paper cup printing apparatus according to claim 10, wherein the cup holder is connected to a vacuum tank, and has a suction hole that sucks one of the paper cups.

12. The paper cup printing apparatus according to claim 10, wherein the cup alignment portion comprises:
a sensing portion that detects the surface of the paper cup that is placed on the cup holder; and
a second drive motor that is fixed to the rotating plate to thus rotate the cup holder.

13. The paper cup printing apparatus according to claim 12, wherein the sensing portion detects a joint portion that is formed in the process of manufacturing the paper cup or a logo printed on the paper cup.

14. The paper cup printing apparatus according to claim 10, wherein a vacuum suction plate is provided at one side of the exit hole, to thus vacuum-suck the lateral surface of the paper cup to maintain the paper cup at a current position if the paper cup reaches the exit hole by rotation of the rotating plate.

15. A paper cup printing method comprising the steps of:
taking a photo;
editing the taken photo;
withdrawing a paper cup;
aligning the paper cup so that the location of the paper cup matches a print position;
printing the photo on the paper cup; and
discharging the paper cup, wherein
the paper cup alignment step comprises the sub-steps of:
rotating the paper cup;
detecting a joint portion or a printed pattern that is formed on the surface of the paper cup; and
stopping rotation of the paper cup if a printing surface of the paper cup is aligned with a laser printer each other.

16. The paper cup printing method of claim 15, wherein the paper cup withdrawing step comprises the sub-steps of:
lifting a cup holder to contact the lower surface of the paper cup;
vacuum-sucking the paper cup that is placed on the cup holder; and
descending the cup holder.

17. The paper cup printing method of claim 15, wherein the step of printing the photo on the paper cup comprises the sub-step of marking the photo on the surface of the paper cup, using the laser printer that uses a CO₂ gas.

18. The paper cup printing method of claim 16, wherein the paper cup discharging step comprises the sub-steps of:
making the cup holder on which the paper cup is placed move to an exit hole;
vacuum-sucking the lateral surface of the paper cup so that the paper cup is fixed on the upper surface of the exit hole;
making the cup holder move back to an original position; and
releasing the vacuum state of the paper cup to thus discharge the paper cup via the exit hole.
